(19) United States
(12) Patent Application Publication
(10) Pub. No.: US 2019/0020586 A1
(43) Pub. Date: Jan. 17, 2019

(54) SELECTIVE INSERTION OF A DEADLOCK RECOVERY BUFFER IN A BUS INTERCONNECT FOR DEADLOCK RECOVERY

(71) Applicant: QUALCOMM Incorporated, San Diego, CA (US)

(72) Inventors: Ravi Karanam, Cary, NC (US); Thomas Basnight, Raleigh, NC (US); Zainab Nasreen Zaidi, Raleigh, NC (US)

(21) Appl. No.: 15/649,985

(22) Filed: Jul. 14, 2017

(51) Int. Cl. H04L 12/801; H04L 12/725; H04L 12/721; H04L 12/933; G06F 9/52; G06F 13/36

(52) U.S. Cl. CPC H04L 47/12; H04L 45/306; G06F 13/36; H04L 49/109; G06F 9/524; H04L 45/127

(57) ABSTRACT

Selective insertion of a deadlock recovery buffer in a bus interconnect for deadlock recovery is provided. A bus interconnect is provided that includes router nodes configured to receive new bus transaction messages from agent devices. The router nodes route the received bus transaction messages to other destination router nodes in the bus interconnect to be communicated to designated agent devices. To recover from a deadlock condition when buffers of all router nodes are full, thus halting forward progress of bus transaction messages, a deadlock recovery circuit is provided. The deadlock recovery circuit is configured to detect a bus deadlock condition in the bus interconnect. In response, the deadlock recovery circuit is configured to insert a deadlock recovery buffer that has additional buffer entries in the bus interconnect as another router node to allow forward progress of bus transaction messages to continue to recover from the deadlock condition.

### BACKGROUND

### I. Field of the Disclosure

The technology of the disclosure relates generally to electronic bus interconnects provided in an integrated circuit (IC) for communicatively interfacing electronic components or systems, and more particularly to deadlock situations that can occur in bus interconnects.

### II. Background

An interconnect communications bus, also referred to as a bus interconnect, is commonly provided in integrated circuit (IC) chips to communicatively interface multiple diverse components or subsystems within a chip. The bus interconnect facilitates point-to-point connections between initiators of communications requests and targets of the communications requests. The bus interconnect is conventionally provided as clocked circuitry, which may include registers, queues, and/or other circuits to manage communications among the various subsystems. The circuitry in the bus interconnect may be clocked with one or more clock signals generated from a master clock signal that operates at a desired bus clock frequency(ies) to provide a desired throughput.

In this regard, ring bus architectures may be provided in bus interconnects to enable high speed point-to-point communications with lower power consumption at high bus clock frequencies. FIG. 1 illustrates an exemplary ring bus interconnect 100 that can be provided in a processor-based system, such as in a system-on-a-chip (SoC), to allow different agent devices therein to communicate with each other. As shown in FIG. 1, the ring bus interconnect 100 includes a plurality of router circuits 102(0)-102(M) (also referred to herein as “router nodes”). Each router node 102(0)-102(M) provides an entry point for routing bus transaction messages 106 that contain data packets, such as requests, received from a requesting agent device 104(0)-104(M) communicatively coupled to a respective router node 102(0)-102(M). The bus transaction messages 106 are routed by the router nodes 102(0)-102(M) to adjacent router nodes 102(0)-102(M) along a ring 108 for each clock cycle of a bus clock until the bus transaction messages 106 reach the router node 102(0)-102(M) that is coupled to the destination agent device 104(0)-104(M). The ring bus interconnect 100 in FIG. 1 also contains two rings 108(1), 108(2) to allow each router node 102(0)-102(M) to route communication packets to adjacent router nodes 102(0)-102(M) in both clockwise and counter clockwise directions to allow each router node 102(0)-102(M) to send and receive bus transaction messages 106 in the same clock cycle without interference.

Each router node 102(0)-102(M) in the ring bus interconnect 100 in FIG. 1 has a buffer 110(0)-110(M) that stores received bus transaction messages 106. In this regard, on each clock cycle, each router node 102(0)-102(M) in the ring bus interconnect 100 in FIG. 1 acts as a sender router node by sending a bus transaction message 106 in its buffer 110(0)-110(M) to an adjacent receiver router node 102(0)-102(M). The data packet associated with the received bus transaction message 106 is stored in the respective buffer 110(0)-110(M) of the receiver router node 102(0)-102(M). However, the sender router node 102(0)-102(M) only sends a bus transaction message 106 to an adjacent router node 102(0)-102(M) acting as a receiver router node if signaled by the receiver router node 102(0)-102(M), because the receiver router node 102(0)-102(M) must have an empty buffer location in its buffer 110(0)-110(M) to store a received bus transaction message 106. Thus, the buffers 110(0)-110(M) in the router nodes 102(0)-102(M) are sized based on design tradeoffs between larger sized buffers allowing more bus transaction messages 106 to be stored to increase the throughput efficiency of the ring bus interconnect 100 versus related complexity and power consumption of larger sized buffers. Nevertheless, with any sized buffers in the ring bus interconnect 100 in FIG. 1, a deadlock situation can arise where every possible buffer entry in the buffers 110(0)-110(M) of the router nodes 102(0)-102(M) is occupied by a data packet. Thus, the data packets will not reach their destination router nodes 102(0)-102(M), because each router node 102(0)-102(M) acting as a receiver router node will not allow its adjacent router node 102(0)-102(M) acting as a sender router node to send a bus transaction message 106 due to no buffer entries being available in the buffers 110(0)-110(M) of the receiver router nodes 102(0)-102(M).

Deadlock in the ring bus interconnect 100 in FIG. 1 can be avoided by employing one of several deadlock avoidance schemes. Deadlock avoidance schemes conventionally involve techniques such as employing bus transaction message routing restrictions where bus transaction messages may be dropped, and thus required to be resent, which is inefficient in terms of utilizing the available bandwidth of a ring bus interconnect. Other deadlock avoidance schemes involve providing dedicated communications paths throughout the ring bus interconnect to avoid deadlock, which is expensive in terms of area and power consumption and can be complex to manage.

### SUMMARY OF THE DISCLOSURE

Aspects disclosed herein include selective insertion of deadlock recovery buffer in a bus interconnect for deadlock recovery. In certain aspects disclosed herein, the bus interconnect includes router nodes (referred to as “router circuits”) that receive new bus transaction messages from agent devices to be asserted into the bus interconnect. The router circuits in the bus interconnect have a buffer configured to store received data packets from received bus transaction messages from another router circuit acting as a sender router circuit. Each router circuit in the bus interconnect can also act as a sender router circuit to send bus transaction messages to a next router circuit acting as a receiver router circuit. A router circuit acting as a sender router circuit sends a bus transaction message to a next router circuit acting as a receiver router circuit in response to the receiver router circuit providing a signal indicating the receiver router circuit has an available buffer entry in its buffer to store a new data packet. However, this can cause a deadlock condition when the buffers of all the router circuits are full, thereby halting forward progress of bus transaction messages.

In this regard, to recover from such a deadlock situation in a bus interconnect, a deadlock recovery circuit is provided in exemplary aspects disclosed herein. The deadlock recovery circuit is configured to detect a bus deadlock condition in the bus interconnect. The deadlock recovery circuit is configured to insert a deadlock recovery buffer in the bus interconnect as another router circuit in response to detection of a bus deadlock condition in the bus interconnect. The deadlock recovery buffer has additional buffer entries that allow new data packets to be stored. In response to the insertion of the deadlock recovery buffer in the bus interconnect, an adjacent sender router circuit to the deadlock recovery buffer can be freed to send previously deadlocked bus transaction messages for buffered data packets to the deadlock recovery buffer. This can then free preceding sender router circuits to the adjacent sender router circuit to do the same and eventually free the bus deadlock condition in the bus interconnect. The deadlock recovery circuit is configured to determine when the bus deadlock condition has been resolved, and in response, de-couple the deadlock recovery buffer from the bus interconnect.

Also, in certain disclosed exemplary aspects, in response to detecting a bus deadlock condition in the bus interconnect, the deadlock recovery circuit is configured to quiesce the bus interconnect. The deadlock recovery circuit can assert a throttle communications signal to the router circuits in the bus interconnect to cause the router circuits to not accept new bus transaction messages from their agent devices. This is so no new bus transaction messages are inserted into the bus interconnect while bus deadlock recovery is being performed in the bus interconnect. In response to the bus deadlock condition being resolved, the deadlock recovery circuit can de-assert the throttle communications signal to allow the router circuits to start accepting new bus transaction messages from their agent devices. Since there are no new bus transaction messages being injected into the bus interconnect during bus deadlock recovery, a bus deadlock condition cannot reoccur until the throttle communications signal is de-asserted in response to the bus deadlock condition being resolved.

In this regard, in one exemplary aspect, a deadlock recovery circuit for a bus interconnect is provided. The deadlock recovery circuit comprises a bus interconnect input interface configured to receive input bus transaction messages from a first router circuit in a bus interconnect, each of the input bus transaction messages comprising a data packet. The deadlock recovery circuit also comprises a bus interconnect output interface configured to receive output bus transaction messages each comprising a data packet from the received input bus transaction messages to be forwarded to a second router circuit in the bus interconnect. The deadlock recovery circuit also comprises a deadlock recovery buffer configured to store at least one data packet. The deadlock recovery circuit is configured to receive the input bus transaction messages on the bus interconnect input interface. The deadlock recovery circuit is also configured to forward the output bus transaction messages on the bus interconnect output interface, each of the output bus transaction messages comprising at least one data packet from the received input bus transaction messages. The deadlock recovery circuit is also configured to detect a deadlock condition in the bus interconnect. In response to the detected deadlock condition in the bus interconnect indicating a deadlock state, the deadlock recovery circuit is also configured to selectively communicatively couple the deadlock recovery buffer to the bus interconnect output interface.

In another exemplary aspect, a deadlock recovery circuit for a bus interconnect is provided. The deadlock recovery circuit comprises a means for receiving input bus transaction messages from a first router circuit in a bus interconnect, each of the input bus transaction messages comprising a data packet. The deadlock recovery circuit also comprises a means for forwarding output bus transaction messages each comprising a data packet from the received input bus transaction messages to a second router circuit in the bus interconnect. The deadlock recovery circuit also comprises a means for storing at least one data packet. The deadlock recovery circuit comprises a means for detecting a deadlock condition in the bus interconnect. The deadlock recovery circuit also comprises a means for selectively communicatively coupling the means for storing to the means for forwarding in response to the detected deadlock condition in the bus interconnect indicating a deadlock state.

In another exemplary aspect, a method for recovering from a detected deadlock condition in a bus interconnect is provided. The method comprises receiving input bus transaction messages from a bus interconnect on a bus interconnect input interface. The method also comprises forwarding output bus transaction messages comprising at least one data packet from the received input bus transaction messages on a bus interconnect output interface. The method also comprises detecting a deadlock condition in the bus interconnect. In response to detecting a deadlock condition in the bus interconnect indicating a deadlock state, the method also comprises selectively communicatively coupling a deadlock recovery buffer configured to store at least one data packet to the bus interconnect output interface, storing the at least one data packet from the received input bus transaction messages in the deadlock recovery buffer, and generating the output bus transaction messages from the stored at least one data packet in the deadlock recovery buffer.

In another exemplary aspect, a bus interconnect system is provided. The bus interconnect system comprises a bus interconnect. The bus interconnect comprises a communications bus. The bus interconnect also comprises a plurality of router circuits each communicatively coupled to the communications bus. Each of the plurality of router circuits is configured to act a sender router circuit to send bus transaction messages on the communications bus and to act as a receiver router circuit to receive the bus transaction messages on the communications bus. The bus interconnect system also comprises a deadlock recovery circuit. The deadlock recovery circuit comprises a bus interconnect input interface communicatively coupled to the bus interconnect configured to receive input bus transaction messages from the bus interconnect, each of the input bus transaction messages comprising a data packet. The deadlock recovery circuit also comprises a bus interconnect output interface configured to receive output bus transaction messages each comprising a data packet from the received input bus transaction messages to be forwarded the bus interconnect. The deadlock recovery circuit also comprises a deadlock recovery buffer configured to store at least one data packet. The deadlock recovery circuit is configured to receive the input bus transaction messages on the bus interconnect input interface, forward the output bus transaction messages on the bus interconnect output interface, each of the output bus transaction messages comprising at least one data packet from the received input bus transaction messages, and detect a deadlock condition in a bus interconnect. In response to the detected deadlock condition in the bus interconnect indicating a deadlock state, the deadlock recovery circuit is also configured to selectively communicatively couple the deadlock recovery buffer to the bus interconnect output interface.

### BRIEF DESCRIPTION OF THE FIGURES

FIG. 1 is a schematic diagram of a ring bus interconnect that can be provided in a processor-based system to facilitate different agent devices therein to communicate with each other;

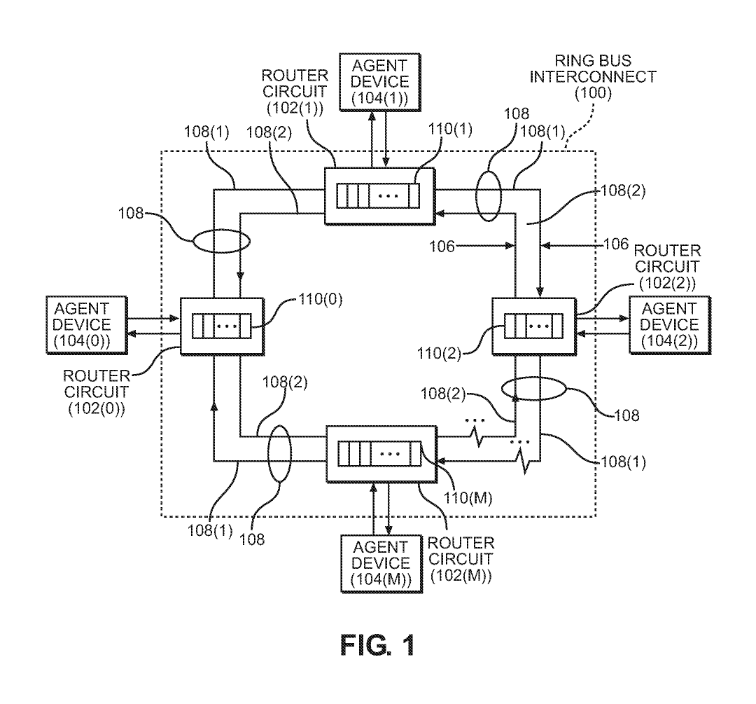

FIG. 2A is a schematic diagram of an exemplary bus interconnect system that includes a bus interconnect and an exemplary deadlock recovery circuit configured to detect a deadlock condition in the bus interconnect and selectively insert a deadlock recovery buffer in the bus interconnect to recover from the deadlock condition in response to detecting a bus deadlock condition;

FIG. 2B is a schematic diagram of an exemplary deadlock recovery circuit that can be included as the deadlock recovery circuit in the bus interconnect in FIG. 2A;

FIG. 3 is a flowchart illustrating an exemplary deadlock detection and recovery process performed by the deadlock recovery circuit in FIGS. 2A and 2B;

FIG. 4A is a schematic diagram of another exemplary bus interconnect system that includes a bus interconnect and an exemplary deadlock recovery circuit configured to detect a deadlock condition in the bus interconnect and selectively insert a deadlock recovery buffer in the bus interconnect to recover from the deadlock condition in response to detecting a bus deadlock condition;

FIG. 4B is a schematic diagram of an exemplary deadlock recovery circuit that can be included as the deadlock recovery circuit in the bus interconnect in FIG. 4A;

FIG. 5 is a diagram of an exemplary state machine that can be performed by the deadlock recovery circuit in the bus interconnect in FIG. 4A to perform a deadlock detection and recovery process in the bus interconnect;

FIG. 6 is a block diagram of an exemplary processor-based system that includes a plurality of central processing units (CPUs) and other agent devices configured to communicate with each other through a bus interconnect that can include a deadlock recovery circuit configured to detect a deadlock condition in the bus interconnect and selectively insert a deadlock recovery buffer in the bus interconnect to recover from the deadlock condition in response to detecting a bus deadlock condition; and

FIG. 7 is a block diagram of an exemplary processor-based system that can include a deadlock recovery circuit(s) for detecting a bus deadlock condition in a bus interconnect(s) and selectively insert and de-couple a deadlock recovery buffer to and from the bus interconnect as part of a deadlock recovery process.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include selective insertion of deadlock recovery buffer in a bus interconnect for deadlock recovery. In certain aspects disclosed herein, the bus interconnect includes router nodes (referred to as “router circuits”) that receive new bus transaction messages from agent devices to be asserted into the bus interconnect. The router circuits in the bus interconnect have a buffer configured to store received data packets from received bus transaction messages from another router circuit acting as a sender router circuit. Each router circuit in the bus interconnect can also act as a sender router circuit to send bus transaction messages to a next router circuit acting as a receiver router circuit. A router circuit acting as a sender router circuit sends a bus transaction message to a next router circuit acting as a receiver router circuit in response to the receiver router circuit providing a signal indicating the receiver router circuit has an available buffer entry in its buffer to store a new data packet. However, this can cause a deadlock condition when the buffers of all the router circuits are full, thereby halting forward progress of bus transaction messages.

In this regard, to recover from such a deadlock situation in a bus interconnect, a deadlock recovery circuit is provided in exemplary aspects disclosed herein. The deadlock recovery circuit is configured to detect a bus deadlock condition in the bus interconnect. The deadlock recovery circuit is configured to insert a deadlock recovery buffer in the bus interconnect as another router circuit in response to detection of a bus deadlock condition in the bus interconnect. The deadlock recovery buffer has additional buffer entries that allow new data packets to be stored. In response to the insertion of the deadlock recovery buffer in the bus interconnect, an adjacent sender router circuit to the deadlock recovery buffer can be freed to send previously deadlocked bus transaction messages for buffered data packets to the deadlock recovery buffer. This can then free preceding sender router circuits to the adjacent sender router circuit to do the same and eventually free the bus deadlock condition in the bus interconnect. The deadlock recovery circuit is configured to determine when the bus deadlock condition has been resolved, and in response, de-couple the deadlock recovery buffer from the bus interconnect.

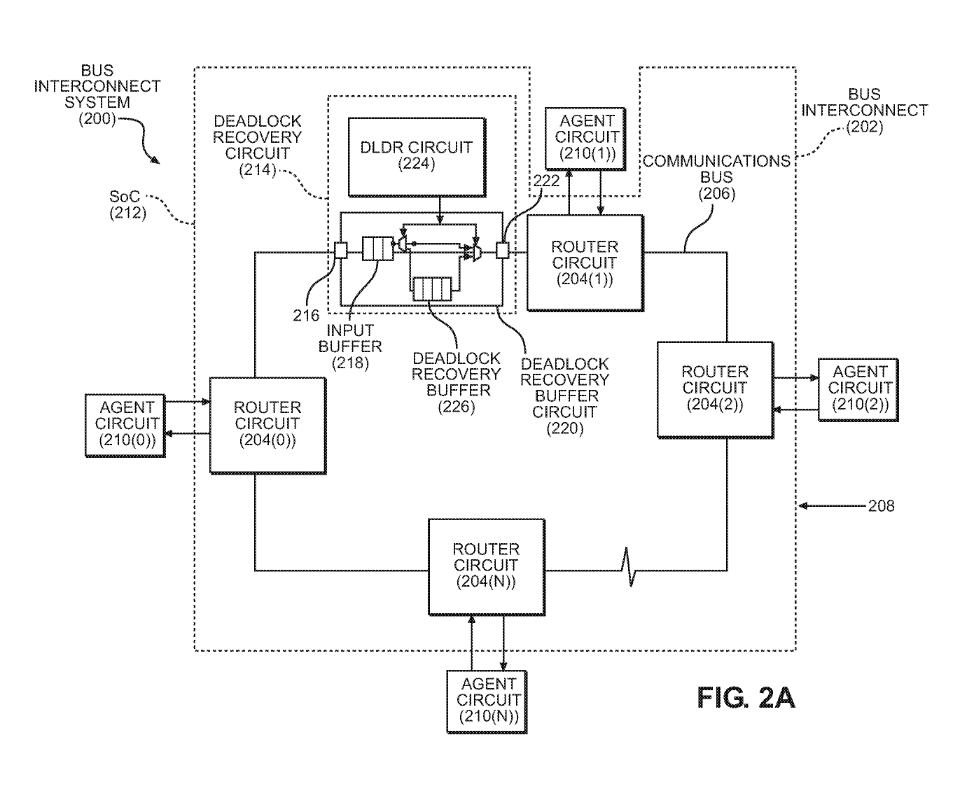

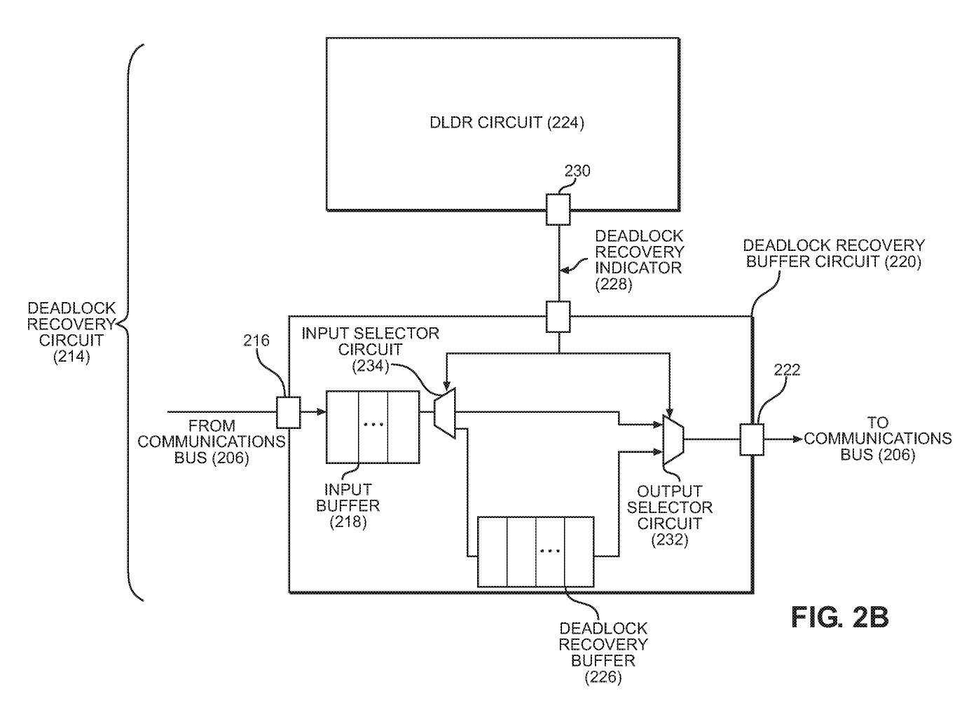

In this regard, FIG. 2A is a schematic diagram of an exemplary bus interconnect system 200 that includes selective insertion of a deadlock recovery buffer in a bus interconnect for deadlock recovery. The bus interconnect system 200 includes a bus interconnect 202. In this example, the bus interconnect 202 is a ring bus interconnect. In the bus interconnect 202, a plurality of router circuits 204(0)-204(N) are coupled in a ring architecture to a communications bus 206. In this example, the communications bus 206 is a two-way communications bus, wherein the router circuits 204(0)-204(N) can send transaction messages in either direction. However, the communications bus 206 could be a one-way communications bus. The router circuits 204(0)-204(N) are each configured to insert bus transaction messages 208 that include one or more data packets from respective agent devices 210(0)-210(N), referred to herein as agent circuits 210(0)-210(N), onto the communications bus 206 that are destined for another agent circuit 210(0)-210(N). In this manner, the bus interconnect system 200 can facilitate communication of bus transaction messages 208 from one agent circuit 210(0)-210(N) acting as a sender agent circuit, to another agent circuit 210(0)-210(N) acting as a receiver agent circuit. In this regard, the router circuits 204(0)-204(N) receive bus transaction messages 208 over the communications bus 206 from an adjacent router circuit 204(0)-204(N). The router circuits 204(0)-204(N) then forward such received bus transaction messages 208 on the communications bus 206 until a router circuit 204(0)-204(N) associated with the recipient agent circuit 210(0)-210(N) receives the bus transaction message 208. The recipient router circuit 204(0)-204(N) distributes the bus transaction message 208 to its destination agent circuit 210(0)-210(N). The bus interconnect 202 may be included in a single integrated circuit (IC) chip, such as a system-on-a-chip (SoC) 212 as an example.

With continuing reference to FIG. 2A, in this example, a router circuit 204(0)-204(N) acting as a sender router circuit may only send a bus transaction message 208 to a next, adjacent router circuit 204(0)-204(N) that has available buffer area to store the data packet associated with the bus transaction message 208. However, if the buffers of the router circuits 204(0)-204(N) are all full, forwarding of bus transaction messages 208 may be halted. This is known as a deadlock condition. In a deadlock condition, forward progress of the bus interconnect 202 is halted. Deadlock avoidance schemes can be implemented to avoid a deadlock condition from occurring. Deadlock avoidance schemes conventionally involve techniques such as employing bus transaction message 208 routing restrictions where bus transaction messages 208 may be dropped, and thus required to be resent, which is inefficient in terms of utilizing the available bandwidth of the bus interconnect system 200. Other deadlock avoidance schemes involve providing dedicated communications paths throughout the bus interconnect 202 to avoid deadlock, which is expensive in terms of area and power consumption and can be complex to manage. Thus, it may be advantageous to implement a deadlock recovery scheme in the bus interconnect 202 where the occurrence of a deadlock condition can be resolved.

In this regard, with continuing reference to FIG. 2A, the bus interconnect 202 includes a deadlock recovery circuit 214. The deadlock recovery circuit 214 is included as part of the bus interconnect 202 like another router circuit 204(0)-204(N). In this example, the deadlock recovery circuit 214 includes a bus interconnect input interface 216 configured to receive input bus transaction messages 208 from a first router circuit, which is router circuit 204(0) in this example. The data packets of the input bus transaction messages 208 are stored in an input buffer 218 in a deadlock recovery buffer circuit 220. The deadlock recovery circuit 214 also includes a bus interconnect output interface 222 configured to receive output bus transaction messages 208 to be forwarded to a second router circuit, which is router circuit 204(1) in this example. The output bus transaction messages 208 are forwarding messages of the data packets stored in the input buffer 218 of the deadlock recovery buffer circuit 220 from the received input bus transaction messages 208. In this regard, the deadlock recovery circuit 214 acts like another router circuit 204(0)-204(N) in the bus interconnect 202.

With continuing reference to FIG. 2A, the bus interconnect 202 may be designed so that bus transaction messages 208 are not forwarded by router circuits 204(0)-204(N) until its adjacent recipient, router circuit 204(0)-204(N), indicates it has available buffer space. If the buffers of the router circuits 204(0)-204(N) and the input buffer 218 of the deadlock recovery buffer circuit 220 become full, a deadlock condition may exist in the bus interconnect 202. A deadlock condition exists in the bus interconnect 202 when forward progress of bus transaction messages 208 is halted.

As will be discussed in more detail below, the deadlock recovery circuit 214 in this example includes a deadlock detection and recovery (DLDR) circuit 224 that is configured to detect a deadlock condition in the bus interconnect 202. To recover from a deadlock condition in the bus interconnect 202, the deadlock recovery buffer circuit 220 in this example includes additional buffer space in the form of the deadlock recovery buffer 226 for providing additional buffer storage for storing data packets from incoming bus transaction messages 208. In response to the DLDR circuit 224 detecting a deadlock condition in the bus interconnect 202 indicating a deadlock state, the DLDR circuit 224 can selectively communicatively couple the deadlock recovery buffer 226 to the bus interconnect input interface 216 and the bus interconnect output interface 222. In this manner, the deadlock recovery buffer 226 provides additional buffer storage for data packets for bus transaction messages 208. Buffer space in the input buffer 218 of the deadlock recovery buffer circuit 220 will become freed and available to the router circuit 204(0) as data packets stored in the input buffer 218 are forwarded to the deadlock recovery buffer 226 to be forwarded in output bus transaction messages 208 to the router circuit 204(1). Eventually, this will free buffer space in the router circuit 204(0) to allow router circuit 204(N) to forward bus transaction messages 208 to router circuit 204(0), and so on. This will free the deadlock condition in the bus interconnect 202. Once the deadlock condition is resolved and the bus interconnect 202 is in a deadlock non-recovery state, the DLDR circuit 224 can be configured to selectively communicatively decouple the deadlock recovery buffer 226 from the bus interconnect input interface 216 and the bus interconnect output interface 222.

FIG. 2B is a schematic diagram that illustrates exemplary detail of the deadlock recovery circuit 214 in the bus interconnect 202 in FIG. 2A to further discuss selective insertion of the deadlock recovery buffer 226 in the bus interconnect 202 for deadlock recovery. In this regard, as discussed, the DLDR circuit 224 is configured to detect a deadlock condition in the bus interconnect 202. For example, the DLDR circuit 224 may be communicatively coupled to the bus interconnect 202 and configured to receive messages or other signals, such as tokens from the other router circuits 204(0)-204(N) (FIG. 2A) indicating if forwarding of bus transaction messages 208 can continue in the bus interconnect 202, or forward progress of bus transaction messages 208 is halted. As shown in FIG. 2B, the DLDR circuit 224 in this example is configured to generate a deadlock recovery indicator 228 on a deadlock recovery interface 230 based on the detected deadlock condition in the bus interconnect 202. The bus interconnect 202 can either be in a deadlock state or a deadlock non-recovery state. The DLDR circuit 224 is configured to generate the deadlock recovery indicator 228 indicating a deadlock recovery state in response to detecting a deadlock condition in the bus interconnect 202 indicating a deadlock state. As will be discussed below, a deadlock recovery state is a state whereby the deadlock recovery circuit 214 is configured to facilitate the bus interconnect 202 recovering from a deadlock condition. The DLDR circuit 224 is configured to generate the deadlock recovery indicator 228 indicating a deadlock non-recovery state in response to not detecting a deadlock condition in the bus interconnect 202 or a deadlock non-recovery state in the bus interconnect 202. For example, a logical ‘1’ value of the deadlock recovery indicator 228 may indicate a deadlock recovery state of the bus interconnect 202, and a logical ‘0’ value of the deadlock recovery indicator 228 may indicate a deadlock non-recovery state, or vice versa.

With continuing reference to FIG. 2B, the deadlock recovery buffer circuit 220 includes an output selector circuit 232. The output selector circuit 232 may be a multiplexer circuit as an example. The output selector circuit 232 is communicatively coupled to the deadlock recovery interface 230 of the DLDR circuit 224. In this regard, the output selector circuit 232 receives the deadlock recovery indicator 228 generated by the DLDR circuit 224. The output selector circuit 232 is configured to selectively communicatively couple (or insert) the deadlock recovery buffer 226 to the bus interconnect output interface 222 in response to the deadlock recovery indicator 228 indicating a deadlock recovery state. In this regard, as discussed above with regard to FIG. 2A, the buffer space in the deadlock recover buffer 226 becomes available for storing forwarded data packets, which in turn can free buffer space in the router circuits 204(0)-204(N) in FIG. 2A. In this example, the deadlock recovery buffer circuit 220 includes the input buffer 218. Thus, the insertion of the deadlock recover buffer 226 in the bus interconnect 202 becomes available for storing forwarded data packets from the input buffer 218. Similarly, when the deadlock recovery indicator 228 indicates a deadlock non-recovery state, the output selector circuit 232 is configured to selectively communicatively de-couple the deadlock recovery buffer 226 to the bus interconnect output interface 222. It may be important to de-couple the deadlock recovery buffer 226 from the bus interconnect output interface 222 when the bus interconnect 202 is not in a deadlock condition, so that the buffer space in the deadlock recovery buffer 226 empties and is again available for use in a subsequent deadlock condition.

As further shown in FIG. 2B, to direct forwarding of data packets from the input buffer 218 to the deadlock recovery buffer 226 in response to the deadlock recovery indicator 228 indicating a deadlock recovery state, another input selector circuit 234 is provided and coupled between the input buffer 218 and the output selector circuit 232 coupled to the bus interconnect output interface 222. The input selector circuit 234 is also coupled to the deadlock recovery interface 230. In this regard, the output selector circuit 232 receives the deadlock recovery indicator 228 generated by the DLDR circuit 224. The input selector circuit 234 is configured to selectively communicatively couple the input buffer 218 to the bus interconnect output interface 222 in response to the deadlock recovery indicator 228 indicating a deadlock non-recovery state so that the deadlock recovery buffer 226 is bypassed. However, when the deadlock recovery indicator 228 indicates a deadlock recovery state, the output selector circuit 232 is configured to selectively communicatively couple the input buffer 218 to the deadlock recovery buffer 226 to direct the forwarding of data packets stored in the input buffer 218 to the deadlock recovery buffer 226. In this example, the input selector circuit 234 and the output selector circuit 232 are controlled together by the deadlock recovery indicator 228 to selectively couple and de-couple the deadlock recovery buffer 226 to and from the bus interconnect 202.

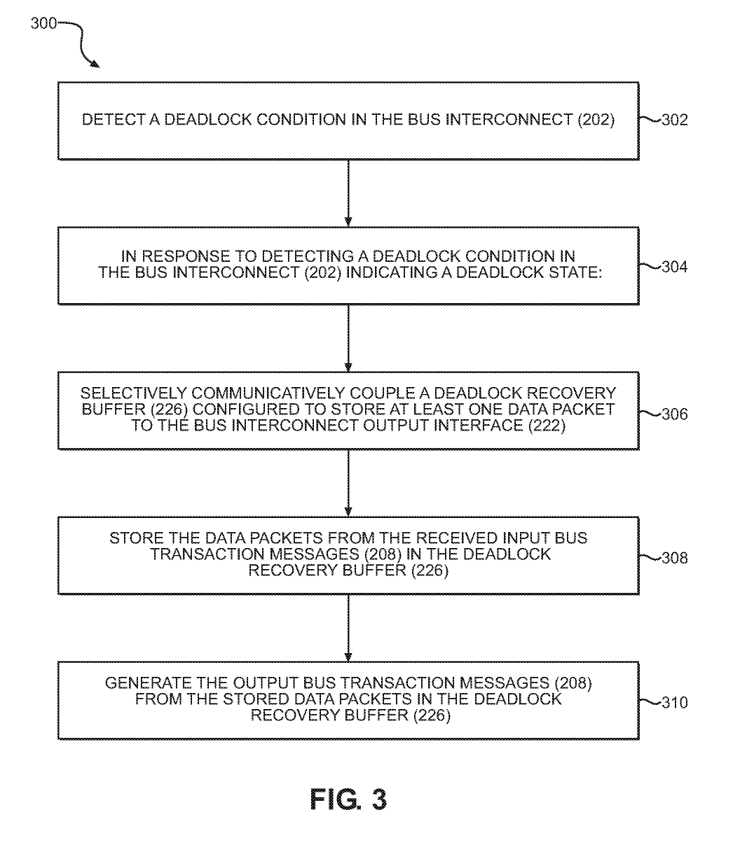

FIG. 3 is a flowchart illustrating an exemplary deadlock detection and recovery process 300 performed by the deadlock recovery circuit 214 in FIGS. 2A and 2B. The deadlock detection and recovery process 300 is discussed with reference to the deadlock recovery circuit 214 in FIGS. 2A and 2B. As shown in FIG. 3, the deadlock recovery circuit 214 is configured to detect a deadlock condition in the bus interconnect 202 (block 302). In response to detecting a deadlock condition in the bus interconnect 202 indicating a deadlock state (block 304), the deadlock recovery circuit 214 is configured to selectively communicatively couple the deadlock recovery buffer 226 to the bus interconnect output interface 222 (block 306). The deadlock recovery circuit 214 is also configured to store data packets from the received input bus transaction messages 208 in the deadlock recovery buffer 226 (block 308). The deadlock recovery circuit 214 is also configured to generate the output bus transaction messages 208 from the stored data packets in the deadlock recovery buffer 226 (block 310). When the deadlock condition no longer persists in the bus interconnect 202, the deadlock recovery circuit 214 is configured to selectively communicatively decouple the deadlock recovery buffer 226 from the bus interconnect output interface 222.

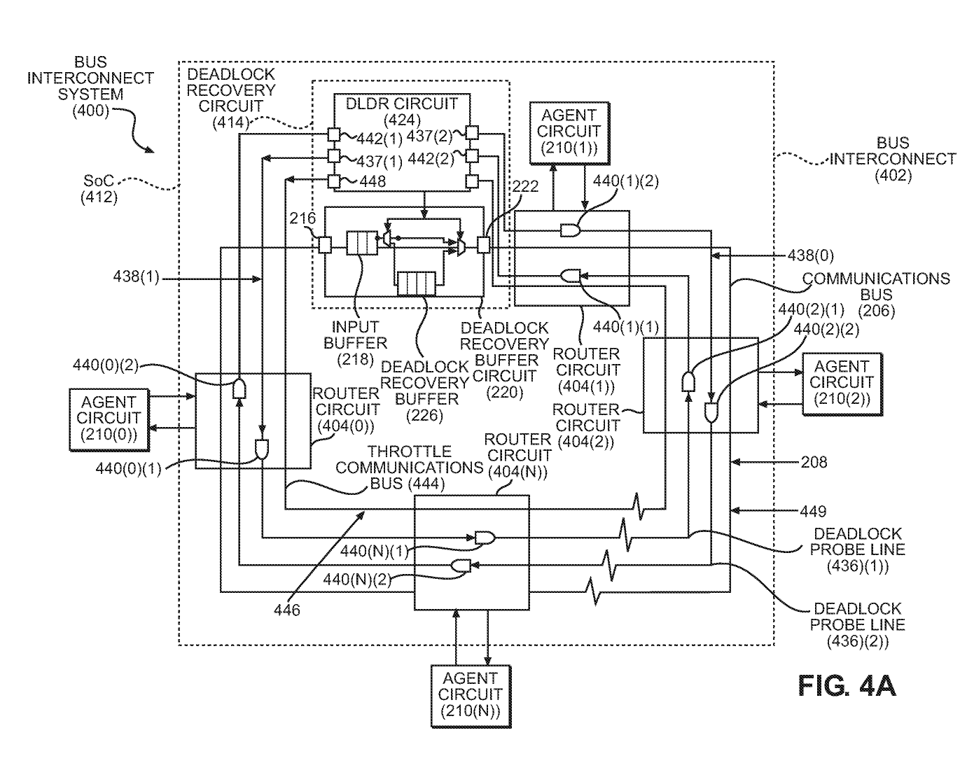

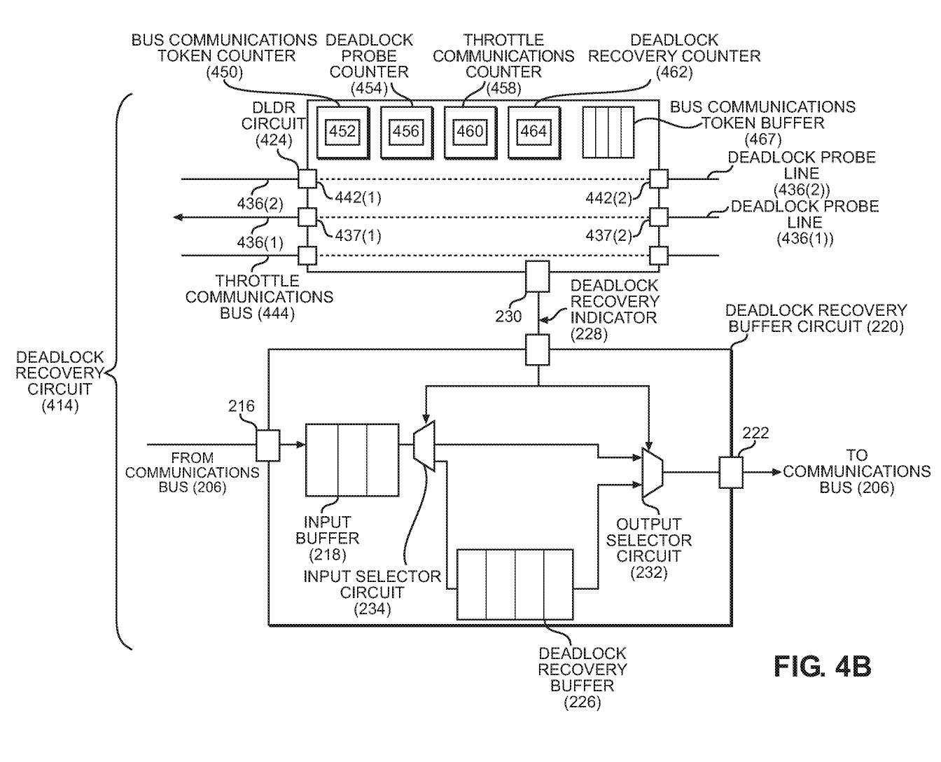

FIG. 4A is a schematic diagram of another exemplary bus interconnect system 400 that also includes selective insertion of a deadlock recovery buffer in a bus interconnect for deadlock recovery. Common elements between the bus interconnect system 400 in FIG. 4A and the bus interconnect system 200 in FIG. 2A are shown with common element numbers. The bus interconnect system 400 includes a bus interconnect 402 that includes a deadlock recovery circuit 414 to recover from deadlock conditions in the bus interconnect 402. As will be discussed in more detail below, the bus interconnect 402 and the deadlock recovery circuit 414 are configured with circuits and mechanisms to facilitate the deadlock recovery circuit 414 detecting of a deadlock condition in the bus interconnect 402. The bus interconnect 402 and deadlock recovery circuit 414 are also configured with circuits and mechanisms that facilitate the deadlock recovery circuit 414 instructing router circuits 404(0)-404(N) in the bus interconnect 402 to not insert new bus transaction messages 208 on the communications bus 206 during deadlock recovery. This is so the buffers of the router circuits 404(0)-404(N) and the deadlock recovery circuit 414 do not continue to remain full during deadlock recovery by the router circuits 404(0)-404(N) in the bus interconnect 402 to not insert new bus transaction messages 208 on the communications bus 206 continuing to insert new bus transaction messages 208 on the communications bus 206.

With continuing reference to FIG. 4A, in this example, the bus interconnect 402 is a ring bus interconnect. In the bus interconnect 402, a plurality of router circuits 404(0)-404(N) are coupled in a ring architecture to the communications bus 206. Similar to the bus interconnect 202 in FIG. 2A, the router circuits 404(0)-404(N) in the bus interconnect 402 in FIG. 4A are each configured to insert bus transaction messages 208 that include one or more data packets from respective agent circuits 210(0)-210(N) onto the communications bus 206 that are destined for another agent circuit 210(0)-210(N). In this manner, the bus interconnect system 400 can facilitate communication of bus transaction messages 208 from one agent circuit 210(0)-210(N) acting as a sender agent circuit, to another agent circuit 210(0)-210(N) acting as a receiver agent circuit. In this regard, the router circuits 404(0)-404(N) receive bus transaction messages 208 over the communications bus 206 from an adjacent router circuit 404(0)-404(N). The router circuits 404(0)-404(N) then forward such received bus transaction messages 208 on the communications bus 206 until a router circuit 404(0)-404(N) associated with the recipient agent circuit 210(0)-210(N) receives the bus transaction message 208. The recipient router circuit 404(0)-404(N) distributes the bus transaction message 208 to its destination agent circuit 210(0)-210(N). The bus interconnect 402 may be included in a single IC chip, such as a SoC 412 as an example.

With continuing reference to FIG. 4A, in this example, a router circuit 404(0)-404(N) acting as a sender router circuit may only send a bus transaction message 208 to a next, adjacent router circuit 404(0)-404(N) that has available buffer area to store the data packet associated with the bus transaction message 208. However, if the buffers of the router circuits 404(0)-404(N) are all full, forwarding of bus transaction messages 208 may be halted. This is known as a deadlock condition. In a deadlock condition, forward progress of the bus interconnect 402 is halted. Thus, it may be advantageous to implement a deadlock recovery scheme in the bus interconnect 202 where the occurrence of a deadlock condition can be resolved.

In this regard, with continuing reference to FIG. 4A, the bus interconnect 402 includes the deadlock recovery circuit 414. The deadlock recovery circuit 414 is included as part of the bus interconnect 402 like another router circuit 404(0)-404(N). In this example, the deadlock recovery circuit 414 includes the deadlock recovery buffer circuit 220 included in the deadlock recovery circuit 214 in FIG. 2A, and thus will not be re-described. The deadlock recovery circuit 414 in this example includes a DLDR circuit 424 that is configured to detect a deadlock condition in the bus interconnect 402. In response to the DLDR circuit 424 detecting a deadlock condition in the bus interconnect 402 indicating a deadlock state, the DLDR circuit 424 can selectively communicatively couple the deadlock recovery buffer 226 to the bus interconnect input interface 216 and the bus interconnect output interface 222 like previously described in FIG. 2A.

With continuing reference to FIG. 4A, the bus interconnect 402 includes some circuitry and mechanisms that facilitate the DLDR circuit 424 detecting a deadlock condition in the bus interconnect 402 and instructing the router circuits 404(0)-404(N) to halt insertion of new bus transaction messages 208 on the communications bus 206 during deadlock recovery. In this regard, as shown in FIG. 4A, the bus interconnect 402 includes two deadlock probe lines 436(1), 436(2). The router circuits 404(0)-404(N) and the DLDR circuit 424 are communicatively coupled to the deadlock probe lines 436(1), 436(2). The DLDR circuit 424 is configured to send deadlock probe signals 438(1), 438(2) over the deadlock probe lines 436(1), 436(2) to determine if a deadlock condition exists in the bus interconnect 402. Two deadlock probe lines 436(1), 436(2) are included in this example for the DLDR circuit 424 to send respective deadlock probe signals 438(1), 438(2) in both directions of the communications bus 206, because the communications bus 206 is a two-way communications bus, where the router circuits 204(0)-204(N) can send bus transaction messages 208 in both directions. However, only one deadlock probe line 436(1) could be provided, for example, if the communications bus 206 were only a one-way communications bus. The DLDR circuit 424 includes output probe interfaces 437(1), 437(2) configured to forward deadlock probe signals 438(1), 438(2) generated and asserted by the DLDR circuit 424 on the respective deadlock probe lines 436(1), 436(2). Each router circuit 404(0)-404(N) includes deadlock indication circuits 440(0)(1)-440(N)(2) that are coupled to the respective deadlock probe lines 436(1), 436(2). If a particular router circuit 404(0)-404(N) is in a deadlock condition, the respective deadlock indication circuits 440(0)(1)-440(N)(2) can alter the deadlock probe signals 438(1), 438(2), such as pulling the deadlock probe signals 438(1), 438(2) to ground for example. The deadlock indication circuits 440(0)(1)-440(N)(2) may be controlled by another signal that indicates if, for example, bus communications tokens 449 are available in the router circuit 404(0)-404(N) indicating that buffer space is available for bus transaction messages 208. If a router circuit 404(0)-404(N) is in a deadlock condition, its respective deadlock indication circuit 440(0)(1)-440(N)(2) can be configured to alter the deadlock probe signals 438(1), 438(2), such as pulling the deadlock probe signals 438(1), 438(2) to ground for example. The DLDR circuit 424 also includes input probe interfaces 442(1), 442(2) configured to receive the deadlock probe signals 438(1), 438(2) asserted on the respective deadlock probe lines 436(1), 436(2). Thus, if a deadlock indication circuit 440(0)(1)-440(N)(2) of a router circuit 404(0)-404(N) alters the deadlock probe signal 438(1), 438(2) indicating a deadlock condition, the DLDR circuit 424 can detect this deadlock condition. In this example, if any router circuit 404(0)-404(N) is in a deadlock condition, the bus interconnect 402 is deemed to be in a deadlock condition.

Also, with continuing reference to FIG. 4A, the bus interconnect 402 may also include a throttle communications bus 444. The throttle communications bus 444 provides a mechanism for a throttle communications signal 446 to be communicated by the DLDR circuit 424 to the router circuits 404(0)-404(N) to instruct the router circuits 404(0)-404(N) to not insert new bus transaction messages 208 on the communications bus 206 during deadlock recovery. In this regard, the DLDR circuit 224 includes a throttle communications interface 448 configured to assert the throttle communications signal 446 on the throttle communications bus 444 to be sent on the bus interconnect 402 to instruct the router circuits 404(0)-404(N) to halt inserting new bus transaction messages 208 on the communications bus 206.

Also, with continuing reference to FIG. 4A, the bus interconnect 402 may facilitate bus communications tokens 449 to be shared between the router circuit 404(0)-404(N) over the communications bus 206 (or over a separate bus if desired) as a credit/debit system for indicating if buffer space is available for forwarding of bus transaction messages 208. The router circuits 404(0)-404(N) may receive bus communication tokens 449 as credits from the communications bus 206 indicating that buffer space is available for forwarding of bus transaction messages 208. The router circuits 404(0)-404(N) may then debit the received bus communications tokens 449 in response to forwarding bus transaction messages 208 on the communications bus 206. This is so that the DLDR circuit 424 receives and manages bus communications credits/debits for the input buffer 218 acting like a buffer in a router circuit 404(0)-404(N).

FIG. 4B is a schematic diagram that illustrates exemplary detail of the deadlock recovery circuit 414 in the bus interconnect 402 in FIG. 4A to further discuss selective insertion of the deadlock recovery buffer 226 in the bus interconnect 402 for deadlock recovery. In this regard, as discussed, the DLDR circuit 424 is configured to detect a deadlock condition in the bus interconnect 402. For example, the DLDR circuit 424 is communicatively coupled to the bus interconnect 402 and configured to receive messages or other signals, such as the deadlock probe signals 438(1), 438(2) on the deadlock probe lines 436(1), 436(2) if forwarding of bus transaction messages 208 can continue in the bus interconnect 402, or forward progress of bus transaction messages 208 is halted. As shown in FIG. 4B, the DLDR circuit 424 in this example is configured to generate a deadlock recovery indicator 228 on a deadlock recovery interface 230 based on the detected deadlock condition in the bus interconnect 402. The bus interconnect 402 can either be in a deadlock state or a deadlock non-recovery state. The DLDR circuit 424 is configured to generate the deadlock recovery indicator 228 indicating a deadlock recovery state in response to detecting a deadlock condition in the bus interconnect 402 indicating a deadlock state based on the state of the deadlock probe signals 438(1), 438(2). The DLDR circuit 424 is also configured generate the deadlock recovery indicator 228 indicating a deadlock non-recovery state in response to not detecting a deadlock condition in the bus interconnect 202 indicating a deadlock state based on the state of the deadlock probe signals 438(1), 438(2). The operation of the deadlock recovery buffer circuit 220 is as described above with regard to FIG. 2A, and thus will not be re-described.

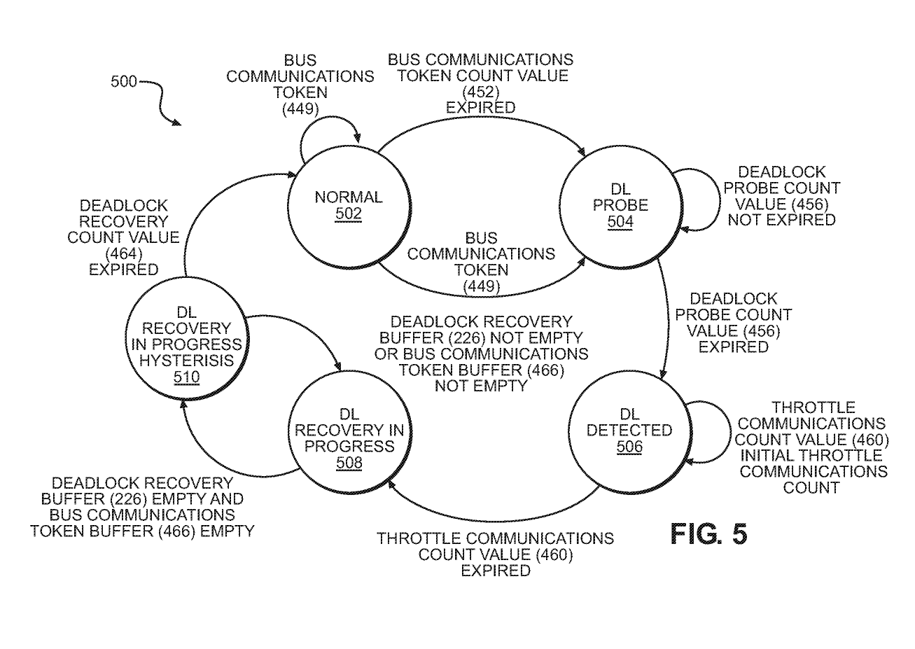

With continuing reference to FIG. 4B, the DLDR circuit 424 in this example includes several exemplary counters to facilitate operations. These counters will be used by the DLDR circuit 424 to perform a state machine 500 in FIG. 5 for performing deadlock detection and recovery in the bus interconnect 402. In this regard, with reference back to FIG. 4B, the DLDR circuit 424 includes a bus communications token counter 450. The bus communications token counter 450 is configured to store a bus communications token count value 452. The bus communications token count value 452 is used to track the bus communications token credits for managing the input buffer 218 in the deadlock recovery buffer circuit 220 as a router circuit. The DLDR circuit 424 also includes a deadlock probe counter 454. The deadlock probe counter 454 is configured to store a deadlock probe count value 456. The deadlock probe counter 454 can be used by the DLDR circuit 424 to determine when to assert a deadlock probe signal 438(1), 438(2) on the deadlock probe lines 436(1), 436(2) to check the deadlock condition of the bus interconnect 402. The deadlock probe count value 456 may be reset by the DLDR circuit 424 in response to the DLDR circuit 424 receiving a bus communications token 449 (see FIG. 4A) as an indication that the bus interconnect 402 is not in a deadlock condition. The DLDR circuit 424 may also include a throttle communications counter 458 that is configured to store a throttle communications count value 460. The DLDR circuit 424 may use the throttle communications counter 458 to provide time for the router circuits 404(0)-404(N) to halt inserting new bus transaction messages 208 on the communications bus 206 in response to the DLDR circuit 424 detecting a deadlock condition. The DLDR circuit 424 may also include a deadlock recovery counter 462 that is configured to store a deadlock recovery count value 464. The DLDR circuit 424 may use the deadlock recovery counter 462 to provide time after a deadlock recovery for the DLDR circuit 424 to then instruct the router circuits 404(0)-404(N) via the throttle communications signal 446 to allow insertion of new bus transaction messages 208 on the communications bus 206. The DLDR circuit 424 may also include a bus communications token buffer 467 that can store the received bus communications tokens 449 and debit received bus communications tokens 449 when forwarding bus transaction messages 208.

FIG. 5 is a diagram of an exemplary state machine 500 that can be performed by the deadlock recovery circuit 414 in in the bus interconnect 402 in FIG. 4A to perform a deadlock detection and recovery process in the bus interconnect 402. The DLDR circuit 424 sets the initial state of the state machine 500 to a NORMAL state 502. In the NORMAL state 502, a deadlock condition has not been detected in the bus interconnect 402 in FIG. 4A. Upon entering the NORMAL state 502, the DLDR circuit 424 stores an initial bus communications token count value 452 in the bus communications token counter 450. The DLDR circuit 424 receives bus communications tokens 449 from the communications bus 206. The DLDR circuit 424 updates the bus communications token count value 452 (e.g., decrementing) based on a clock signal. The DLDR circuit 424 detects if a deadlock condition exists in the bus interconnect 402 based on whether bus communications tokens 449 are received from the bus interconnect 402 before the bus communications token count value 452 expires. If the DLDR circuit 424 has not received bus communications token 449 before the bus communications token counter 450 expires, meaning that the bus communications token count value 452 has exceeded a specified threshold value, this means that the bus interconnect 402 may be in a deadlock condition.

With continuing reference to FIG. 5, if the bus communications token count value 452 expires, the DLDR circuit 424 enters a deadlock (DL) PROBE state 504. Upon entering the DL PROBE state 504, the DLDR circuit 424 stores an initial deadlock probe count value 456 in the deadlock probe counter 454. The DLDR circuit 424 updates the deadlock probe count value 456 (e.g., decrementing) based on a clock signal. If a bus communications token 449 is received before the deadlock probe count value 456 expires, meaning that the bus communications token count value 452 has exceeded a specified threshold value, the DLDR circuit 424 returns to the NORMAL state 502 because bus transaction messages 208 are again allowed to be forwarded. However, if the deadlock probe count value 456 expires before any bus communications tokens 449 are received, the DLDR circuit 424 asserts the deadlock probe signals 438(1), 438(2) on the deadlock probe lines 436(1), 436(2) to determine if a deadlock condition exists in the bus interconnect 402 as previously described above with regard to FIGS. 4A and 4B. This is because not receiving bus communications tokens 449 may be an indication that the bus interconnect 402 is in a deadlock condition. If a deadlock condition is detected based on the state of the deadlock probe signals 438(1), 438(2), the DLDR circuit 424 transitions to a DL DETECTED state 506.

With continuing reference to FIG. 5, in the DL DETECTED state 506, the DLDR circuit 424 asserts the throttle communications signal 446 on the throttle communications bus 444 to instruct the router circuits 404(0)-404(N) to not insert new bus transaction messages 208 on the communications bus 206 as previously discussed above. The DLDR circuit 424 then initializes the throttle communications counter 458 to an initial throttle communications count value 460. The DLDR circuit 424 updates the throttle communications count value 460 in the throttle communications counter 458 based on a clock signal. When the throttle communications count value 460 expires, this means enough time has been given to the router circuits 404(0)-404(N) to stop inserting new bus transaction messages 208 on the communications bus 206. Thereafter, the DLDR circuit 424 enters a DL RECOVERY IN PROGRESS state 508 in FIG. 5.

With continuing reference to FIG. 5, in the DL RECOVERY IN PROGRESS state 508, the DLDR circuit 424 is configured to generate the deadlock recovery indicator 228 indicating a deadlock recovery state. As discussed above with regard to FIGS. 4A and 4B, this causes the deadlock recovery buffer circuit 220 to insert the deadlock recovery buffer 226 in the bus interconnect 402. The throttle communications signal 446 stays asserted by the DLDR circuit 424 in the DL RECOVERY IN PROGRESS state 508. The deadlock probe signals 438(1), 438(2) are de-asserted in the by the DLDR circuit 424 in the DL RECOVERY IN PROGRESS state 508. Whenever bus communications tokens 449 become available, the deadlock recovery buffer 226 is emptied first. The DLDR circuit 424 stays in the DL RECOVERY IN PROGRESS state 508 for as long as either the deadlock recovery buffer 226 or the bus communications token buffer 466 are not empty. Once both the deadlock recovery buffer 226 and the bus communications token buffer 466 are empty, the DLDR circuit 424 enters a DL RECOVERY IN PROGRESS HYSTERISIS state 510.

With continuing reference to FIG. 5, when the DLDR circuit 424 enters the DL RECOVERY IN PROGRESS HYSTERISIS state 510, the DLDR circuit 424 initializes the deadlock recovery counter 462 to the initial deadlock recovery count value 464. The DLDR circuit 424 updates the deadlock recovery count value 464 in the deadlock recovery counter 462 based on a clock signal. If either the deadlock recovery buffer 226 of the bus communications token buffer 466 becomes non-empty again, the DLDR circuit 424 transitions back to the DL RECOVERY IN PROGRESS state 508, because the deadlock condition has not yet been fully recovered. However, if the deadlock recovery count value 464 expires, meaning the deadlock recovery count value 464 exceeds a defined threshold, then before either the deadlock recovery buffer 226 of the bus communications token buffer 466 becomes non-empty again, the deadlock condition is deemed to have been fully recovered from. The DLDR circuit 424 then transitions back to the NORMAL state 502.

In another example, a deadlock recovery circuit for a bus interconnect can be provided. The deadlock recovery circuit includes a means for receiving input bus transaction messages from a first router circuit in a bus interconnect, each of the input bus transaction messages comprising a data packet. The means for receiving input bus transaction messages could be the deadlock recovery circuits 214, 414 in FIGS. 2A and 4A as non-limiting examples, and also the deadlock recovery buffer circuit 220 in FIGS. 2A and 4A as other non-limiting examples. The deadlock recovery circuit also includes a means for forwarding output bus transaction messages each comprising a data packet from the received input bus transaction messages to a second router circuit in the bus interconnect. The means for forwarding output bus transaction messages could be the deadlock recovery circuits 214, 414 in FIG. 2A or 4A as non-limiting examples, and also the deadlock recovery buffer circuit 220 in FIG. 2A or 4A as other non-limiting examples. The deadlock recovery circuit also includes a means for storing at least one data packet, which could be the deadlock recovery buffer circuit 220 in FIG. 2A or 4A, and also the deadlock recovery buffer 226 in FIG. 2A or 4A. The deadlock recovery circuit also includes a means for detecting a deadlock condition in the bus interconnect. The means for detecting a deadlock condition in the bus interconnect could include the DLDR circuits 224, 424 in FIG. 2A or 4A. The deadlock recovery circuit also includes a means for selectively communicatively coupling the means for storing to the means for forwarding in response to the detected deadlock condition in the bus interconnect indicating a deadlock state. The means for selectively communicatively coupling the means for storing to the means for forwarding could include the DLDR circuits 224, 424 in FIG. 2A or 4A, and the deadlock recovery buffer circuit 220 in FIG. 2A or 4A.

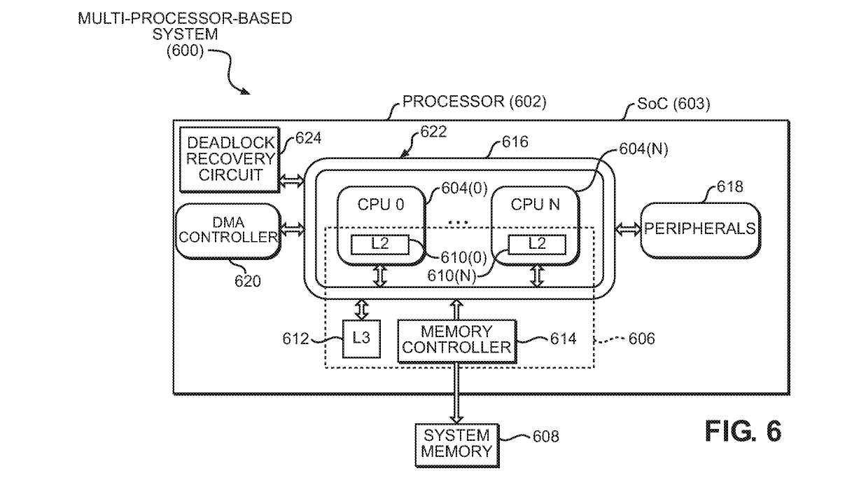

The deadlock recovery circuits discussed herein, including the deadlock recovery circuits 214, 414 in FIGS. 2B and 4B, can be included in a processor-based system to facilitate bus interconnects therein to recover from deadlocks. In this regard, an example of such a processor-based system is shown in FIG. 6. FIG. 6 is a block diagram of an exemplary multi-processor-based system 600 that includes a processor 602 that may be provided as a SoC 603. The processor 602 includes a plurality of central processing units (CPUs) 604(0)-604(N) and a cache memory system 606 for storing cached data entries with data in a system memory 608. In this example, the cache memory system 606 includes a hierarchy of local, private cache memories 610(0)-610(N) on-chip with and accessible only to each respective CPU 604(0)-604(N) that form a shared lower-level cache memory accessible to all CPUs 604(0)-604(N), and a public shared cache memory 612 (e.g., a level 3 (L3) cache memory). The public shared cache memory 612 may be a last-level cache (LLC) memory that is a last level of cache memory before the system memory 608 is accessed. A memory controller 614 controls accesses to the system memory 608. For example, the system memory 608 may be a dynamic read access memory (DRAM). An internal bus interconnect 616, which may be a coherent interconnect ring bus, is provided that allows each of the CPUs 604(0)-604(N) to access the non-local private cache memories 610(0)-610(N) of other CPUs 604(0)-604(N). Other shared resources that can be accessed by the CPUs 604(0)-604(N) through the bus interconnect 616 can include the memory controller 614 for accessing the system memory 608, peripherals 618, and a direct memory access (DMA) controller 620. These shared resources coupled to the internal bus interconnect 116 may act as router circuits to route bus transaction messages 622 between the shared resources. A deadlock recovery circuit 624 configured to selectively insert a deadlock recovery buffer circuit in the bus interconnect 616 for deadlock recovery is also coupled to the bus interconnect 616 to facilitate recovery from deadlocks in the bus interconnect 616. The deadlock recovery circuit 624 could be the deadlock recovery circuits 214, 414 in FIGS. 2B and 4B described above, as non-limiting examples.

Deadlock recovery circuits configured to selectively insert a deadlock recovery buffer in a bus interconnect for deadlock recovery according to aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

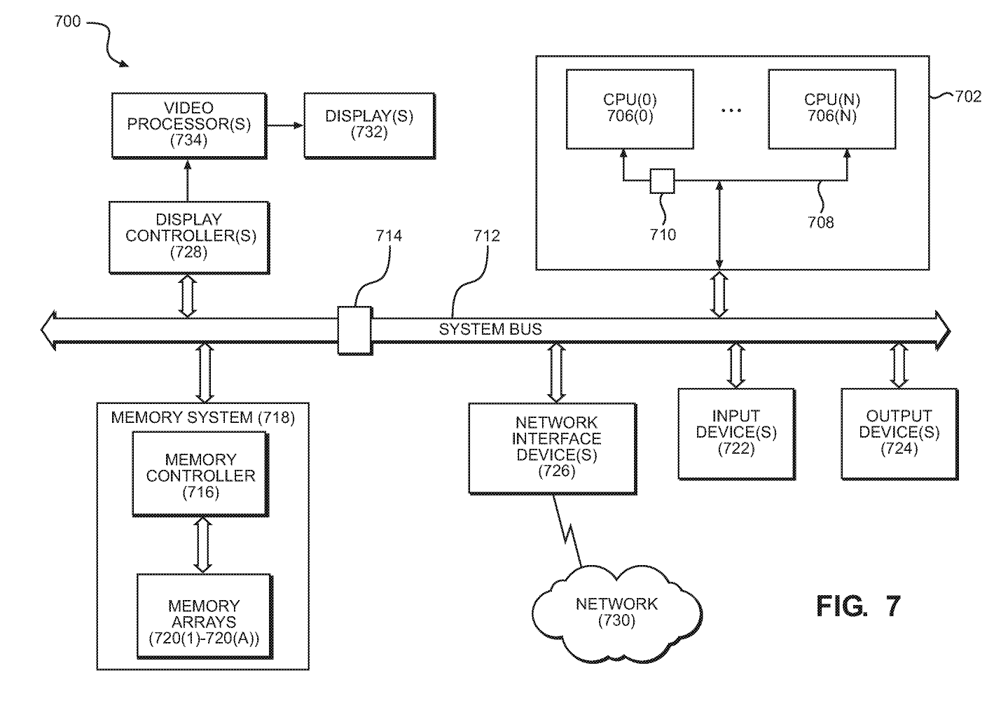

In this regard, FIG. 7 illustrates an example of a processor-based system 700. In this example, the processor-based system 700 includes a processor 702 that includes a plurality of CPUs 706(0)-706(N). The processor 702 could be the processor 602 in FIG. 6 where the CPUs 706(0)-706(N) are the CPUs 604(0)-604(N). With reference back to FIG. 7, the CPUs 706(0)-706(N) may be communicatively coupled by a bus interconnect 708, which may include a deadlock recovery circuit 710 configured to selectively insert a deadlock recovery buffer circuit in the bus interconnect 708 to facilitate the bus interconnect 708 recovering from a deadlock condition. The deadlock recovery circuit 710 could be the deadlock recovery circuits 214, 414 in FIGS. 2B and 4B described above, as non-limiting examples. The CPUs 706(0)-706(N) can issue memory access commands over the shared bus interconnect 708 to go out over a system bus 712. The system bus 712 may also include a deadlock recovery circuit 714 configured to selectively insert a deadlock recovery buffer circuit in the system bus 712. The deadlock recovery circuit 714 could be the deadlock recovery circuits 214, 414 in FIGS. 2B and 4B described above, as non-limiting examples. Memory access requests issued by the CPUs 706(0)-706(N) go out over the system bus 712 to a memory controller 716 in a memory system 718 that includes a plurality of memory arrays 720(1)-720(A). Although not illustrated in FIG. 7, multiple system buses 712 could be provided, wherein each system bus 712 constitutes a different fabric. For example, the CPUs 706(0)-706(N) can communicate bus transaction requests to the memory system 718 as an example of a slave device.

Other master and slave devices can be connected to the system bus 712. As illustrated in FIG. 7, these devices can include the memory system 718, one or more input devices 722, one or more output devices 724, one or more network interface devices 726, and one or more display controllers 728. The input device(s) 722 can include any type of input device, including but not limited to input keys, switches, voice processors, etc. The output device(s) 724 can include any type of output device, including but not limited to audio, video, other visual indicators, etc. The network interface device(s) 726 can be any devices configured to allow exchange of data to and from a network 730. The network 730 can be any type of network, including but not limited to a wired or wireless network, a private or public network, a local area network (LAN), a wireless local area network (WLAN), a wide area network (WAN), a BLUETOOTH™ network, and the Internet. The network interface device(s) 726 can be configured to support any type of communications protocol desired.

The CPUs 706(0)-706(N) can also be configured to access the display controller(s) 728 over the system bus 712 to control information sent to one or more displays 732. The display controller(s) 728 sends information to the display(s) 732 to be displayed via one or more video processors 734, which process the information to be displayed into a format suitable for the display(s) 732. The display(s) 732 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A deadlock recovery circuit for a bus interconnect, comprising:
a bus interconnect input interface configured to receive input bus transaction messages from a first router circuit in a bus interconnect, each of the input bus transaction messages comprising a data packet;
a bus interconnect output interface configured to receive output bus transaction messages each comprising a data packet from the received input bus transaction messages to be forwarded to a second router circuit in the bus interconnect; and
a deadlock recovery buffer configured to store at least one data packet;
the deadlock recovery circuit configured to:
receive the input bus transaction messages on the bus interconnect input interface;
forward the output bus transaction messages on the bus interconnect output interface, each of the output bus transaction messages comprising at least one data packet from the received input bus transaction messages;
detect a deadlock condition in the bus interconnect; and
in response to the detected deadlock condition in the bus interconnect indicating a deadlock state, selectively communicatively couple the deadlock recovery buffer to the bus interconnect output interface.

2. The deadlock recovery circuit of claim 1, further configured to:
store the data packets from the received input bus transaction messages in the deadlock recovery buffer; and
generate the output bus transaction messages from the at least one stored data packet in the deadlock recovery buffer.

3. The deadlock recovery circuit of claim 1, further configured to, in response to the detected deadlock condition in the bus interconnect indicating a deadlock non-recovery state, selectively communicatively decouple the deadlock recovery buffer from the bus interconnect input interface and the bus interconnect output interface.

4. The deadlock recovery circuit of claim 1, further comprising:
a deadlock recovery detection and recovery (DLDR) circuit comprising a deadlock recovery interface, the DLDR circuit configured to:
detect the deadlock condition in the bus interconnect;
generate a deadlock recovery indicator on the deadlock recovery interface based on the detected deadlock condition in the bus interconnect; and
in response to the detected deadlock condition in the bus interconnect indicating a deadlock state, generate the deadlock recovery indicator indicating a deadlock recovery state; and
a deadlock recovery buffer circuit comprising the deadlock recovery buffer and an output selector circuit communicatively coupled to the deadlock recovery interface;
the output selector circuit configured to selectively communicatively couple the deadlock recovery buffer to the bus interconnect output interface in response to the deadlock recovery indicator indicating the deadlock recovery state.

5. The deadlock recovery circuit of claim 4, wherein:
the DLDR circuit is further configured to, in response to the detected deadlock indicator indicating a deadlock non-recovery state, generate the deadlock recovery indicator indicating a deadlock non-recovery state; and
the output selector circuit is further configured to selectively communicatively decouple the deadlock recovery buffer from the bus interconnect output interface in response to the deadlock recovery indicator indicating the deadlock non-recovery state.

6. The deadlock recovery circuit of claim 4, wherein the deadlock recovery buffer circuit comprises:
an input buffer configured to store at least one data packet from the received input bus transaction messages;
the deadlock recovery buffer configured to store the at least one data packet from the received input bus transaction messages; and
an input selector circuit communicatively coupled to the input buffer, the input selector circuit configured to:
selectively communicatively couple the input buffer to the deadlock recovery buffer in response to the deadlock recovery indicator indicating the deadlock recovery state; and
selectively communicatively couple the input buffer to the output selector circuit in response to the deadlock recovery indicator indicating the deadlock non-recovery state.

7. The deadlock recovery circuit of claim 4, wherein the DLDR circuit is further configured to:
receive bus communications tokens from the bus interconnect; and
detect the deadlock condition in the bus interconnect based on whether the bus communications tokens are received from the bus interconnect.

8. The deadlock recovery circuit of claim 7, further comprising a bus communications token counter configured to store a bus communications token count value;
the DLDR circuit further configured to:
store an initial bus communications token count value in the bus communications token counter;
update the bus communications token count value in the bus communications token counter based on a clock signal; and
detect the deadlock condition in the bus interconnect based on whether the bus communications tokens are received from the bus interconnect before the bus communications token count value expires.

9. The deadlock recovery circuit of claim 4, wherein the DLDR circuit further comprises:
an input probe interface configured to receive a deadlock probe signal from the bus interconnect; and
an output probe interface configured to receive a deadlock probe signal to be sent to the bus interconnect;
the DLDR circuit further configured to detect the deadlock condition of the bus interconnect by being configured to:
assert a deadlock probe signal on the output probe interface indicating a deadlock non-recovery state on a deadlock probe line in the bus interconnect;
receive the deadlock probe signal on the input probe interface indicating the deadlock condition of the bus interconnect in response to the assertion of the deadlock probe signal on the output probe interface; and
detect the deadlock condition in the bus interconnect based on the received deadlock probe signal.

10. The deadlock recovery circuit of claim 9, wherein the DLDR circuit is further configured to detect the deadlock condition in the bus interconnect in a deadlock state if the deadlock probe signal on the input probe interface indicates a deadlock state.

11. The deadlock recovery circuit of claim 9, further comprising a deadlock probe counter configured to store a deadlock probe count value;
the DLDR circuit further configured to:
initialize the deadlock probe counter to an initial deadlock probe count value in response to assertion of the deadlock probe signal on the output probe interface;
update the deadlock probe count value in the deadlock probe counter based on a clock signal; and
detect the deadlock condition in the bus interconnect based on the received deadlock probe signal when the deadlock probe count value of the deadlock probe counter has expired.

12. The deadlock recovery circuit of claim 11, wherein the DLDR circuit is further configured to detect the deadlock condition in the bus interconnect in a deadlock non-recovery state in response to receipt of a bus communications token from the bus interconnect before the deadlock probe count value of the deadlock probe counter has expired.

13. The deadlock recovery circuit of claim 4, further comprising:
a throttle communications interface configured to receive a throttle communications signal to be sent to the bus interconnect to halt new bus transaction messages from being injected into the bus interconnect; and
a throttle communications counter configured to store a throttle communications count value;
the DLDR circuit further configured to, in response to the detected deadlock condition in the bus interconnect indicating the deadlock state:
initialize the throttle communications counter to an initial throttle communications count value;
update the throttle communications count value in the throttle communications counter based on a clock signal; and
in response to expiration of the throttle communications count value in the throttle communications counter, generate the deadlock recovery indicator indicating the deadlock recovery state.

14. The deadlock recovery circuit of claim 5, wherein the DLDR circuit is further configured to:
determine if the deadlock recovery buffer is empty; and
generate the deadlock recovery indicator indicating the deadlock non-recovery state in response to receipt of a bus communications token from the bus interconnect and the deadlock recovery buffer being empty.

15. The deadlock recovery circuit of claim 14, further comprising a deadlock recovery counter configured to store a deadlock recovery count value;
the DLDR circuit further configured to, in response to the detected deadlock condition in the bus interconnect indicating the deadlock state:
initialize the deadlock recovery counter to an initial deadlock recovery count value;
update the deadlock recovery count value in the deadlock recovery counter based on a clock signal; and
in response to expiration of the deadlock recovery count value in the deadlock recovery counter, generate the deadlock recovery indicator indicating the deadlock non-recovery state in response to receipt of a bus communications token from the bus interconnect and the deadlock recovery buffer being empty.

16. The deadlock recovery circuit of claim 4, wherein the DLDR circuit comprises the deadlock recovery buffer circuit.

17. The deadlock recovery circuit of claim 1 integrated into a system-on-a-chip (SoC).

18. The deadlock recovery circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

19. A deadlock recovery circuit for a bus interconnect, comprising:
a means for receiving input bus transaction messages from a first router circuit in a bus interconnect, each of the input bus transaction messages comprising a data packet;
a means for forwarding output bus transaction messages each comprising a data packet from the received input bus transaction messages to a second router circuit in the bus interconnect;
a means for storing at least one data packet;
a means for detecting a deadlock condition in the bus interconnect; and
a means for selectively communicatively coupling the means for storing to the means for forwarding in response to the detected deadlock condition in the bus interconnect indicating a deadlock state.

20. A method for recovering from a detected deadlock condition in a bus interconnect, comprising:
receiving input bus transaction messages from a bus interconnect on a bus interconnect input interface;
forwarding output bus transaction messages comprising at least one data packet from the received input bus transaction messages on a bus interconnect output interface;
detecting a deadlock condition in the bus interconnect; and
in response to detecting a deadlock condition in the bus interconnect indicating a deadlock state:
selectively communicatively coupling a deadlock recovery buffer configured to store at least one data packet to the bus interconnect output interface;
storing the at least one data packet from the received input bus transaction messages in the deadlock recovery buffer; and
generating the output bus transaction messages from the stored at least one data packet in the deadlock recovery buffer.

21. The method of claim 20, wherein, in response to detecting the deadlock condition in the bus interconnect indicating a deadlock non-recovery state:
selectively communicatively decoupling the deadlock recovery buffer from the bus interconnect output interface;
selectively communicatively decoupling the deadlock recovery buffer from the bus interconnect input interface and the bus interconnect output interface; and
generating the output bus transaction messages directly from the input bus transaction messages.

22. The method of claim 20,
further comprising:
generating a deadlock recovery indicator based on the detected deadlock condition in the bus interconnect;
in response to the detected deadlock condition in the bus interconnect indicating a deadlock state, generating the deadlock recovery indicator indicating a deadlock recovery state; and
selectively communicatively coupling the deadlock recovery buffer to the bus interconnect output interface in response to the deadlock recovery indicator indicating the deadlock recovery state.

23. The method of claim 22, further comprising:
receiving bus communications tokens from the bus interconnect; and
detecting the deadlock condition in the bus interconnect based on whether the bus communications tokens are received from the bus interconnect.

24. The method of claim 23,
further comprising:
storing an initial bus communications token count value in a bus communications token counter; and
updating a bus communications token count value in the bus communications token counter based on a clock signal; and
detecting the deadlock condition in the bus interconnect based on whether bus communications tokens are received from the bus interconnect before the bus communications token count value expires.

25. The method of claim 22, wherein detecting the deadlock condition in the bus interconnect comprises:
asserting a deadlock probe signal indicating a deadlock non-recovery state on a deadlock probe line in the bus interconnect;
receiving the deadlock probe signal indicating a deadlock condition of the bus interconnect in response to the assertion of the deadlock probe signal; and
detecting the deadlock condition in the bus interconnect based on the received deadlock probe signal.

26. The method of claim 25, further comprising detecting the deadlock condition in the bus interconnect in a deadlock state if the deadlock probe signal on the input probe interface indicates a deadlock state.

27. The method of claim 26,
further comprising:
initializing the deadlock probe counter to an initial deadlock probe count value in response to the assertion of the deadlock probe signal;
updating a deadlock probe count value in the deadlock probe counter based on a clock signal; and
detecting the deadlock condition in the bus interconnect based on the received deadlock probe signal when the deadlock probe count value of the deadlock probe counter has expired.

28. The method of claim 27, further comprising detecting the deadlock condition in the bus interconnect in a deadlock non-recovery state in response to receipt of a bus communications token from the bus interconnect before the deadlock probe count value of the deadlock probe counter has expired.

29. The method of claim 22, further comprising, in response to detecting the deadlock condition in the bus interconnect indicating the deadlock state:
initializing a throttle communications counter to an initial throttle communications count value;
updating a throttle communications count value in the throttle communications counter based on a clock signal; and
in response to expiration of the throttle communications count value in the throttle communications counter, generating the deadlock recovery indicator indicating the deadlock recovery state.

30. The method of claim 22, further comprising:
determining if the deadlock recovery buffer is empty; and
generating the deadlock recovery indicator indicating the deadlock non-recovery state in response to receipt of a bus communications token from the bus interconnect and the deadlock recovery buffer being empty.

31. The method of claim 30, wherein, in response to detecting the deadlock condition in the bus interconnect indicating the deadlock state:
initializing a deadlock recovery counter to an initial deadlock recovery count value;
updating a deadlock recovery count value in the deadlock recovery counter based on a clock signal; and
in response to expiration of the deadlock recovery count value in the deadlock recovery counter, generating the deadlock recovery indicator indicating the deadlock non-recovery state in response to receipt of a bus communications token from the bus interconnect and the deadlock recovery buffer being empty.

32. A bus interconnect system, comprising:
a bus interconnect, comprising:
a communications bus; and
a plurality of router circuits each communicatively coupled to the communications bus, each of the plurality of router circuits configured to act as a sender router circuit to send bus transaction messages on the communications bus and to act as a receiver router circuit to receive the bus transaction messages on the communications bus; and
a deadlock recovery circuit, comprising:
a bus interconnect input interface communicatively coupled to the bus interconnect configured to receive input bus transaction messages from the bus interconnect, each of the input bus transaction messages comprising a data packet;
a bus interconnect output interface configured to receive output bus transaction messages each comprising a data packet from the received input bus transaction messages to be forwarded to the bus interconnect; and
a deadlock recovery buffer configured to store at least one data packet;
the deadlock recovery circuit configured to:
receive the input bus transaction messages on the bus interconnect input interface;
forward the output bus transaction messages on the bus interconnect output interface, each of the output bus transaction messages comprising at least one data packet from the received input bus transaction messages;
detect a deadlock condition in the bus interconnect; and
in response to the detected deadlock condition in the bus interconnect indicating a deadlock state, selectively communicatively couple the deadlock recovery buffer to the bus interconnect output interface.

33. The bus interconnect system of claim 32, further comprising a deadlock probe signal bus configured to receive a deadlock probe signal;
each of the plurality of router circuits communicatively coupled to the deadlock probe signal bus and configured to assert a deadlock state on the deadlock probe signal; and
the deadlock recovery circuit configured to detect the deadlock condition in the bus interconnect by being configured to:
assert a deadlock probe signal on the deadlock probe signal bus indicating a deadlock non-recovery state; and
receive the deadlock probe signal from the deadlock probe signal bus indicating a deadlock condition of the bus interconnect in response to the assertion of the deadlock probe signal on the deadlock probe signal bus; and
detect the deadlock condition in the bus interconnect in a deadlock state if the deadlock probe signal indicates a deadlock state.
